(19) United States
(12) Patent Application Publication
(10) Pub. No.: US 2005/0240954 A1
(43) Pub. Date: Oct. 27, 2005

(54) Disk drive unit, and information recording and regeneration apparatus

(76) Inventors: Takeo Santo, Hirakata-shi (JP); Yoshito Saji, Ashiya-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/113,083

(22) Filed: Apr. 25, 2005

(30) Foreign Application Priority Data
Apr. 27, 2004 (JP) 2004-130957

(51) Int. Cl. G11B 17/03; G11B 17/028; G11B 19/20

(52) U.S. Cl. 720/715; 720/601; 720/703

(57) ABSTRACT

A disk drive unit is provided which is capable of restraining a disk from being tilted by the weight of the disk itself, using a simple configuration. In this disk drive unit, a turntable is provided below a disk, and a pressure member is provided above the disk. The turntable includes a disk mounting portion which comes into contact with the disk. The pressure member includes a pressure portion which presses the lower surface of the disk and rotates together with the disk. An aligning ring presses the interior-end part of the disk from below. The disk mounting portion is located on the inside in the radius direction from the pressure portion.

### BACKGROUND OF THE INVENTION

1. Field of the Invention

The present invention relates to a disk drive unit which drives a disk-shaped information record medium such as an optical disk. Specifically, it relates to the art of holding a disk-shaped information record medium.

2. Description of the Related Art

In recent years, a portable disk-shaped signal record medium, such as an optical disk and a magnetic disk, has been increasingly popular. Simultaneously, its recording density has become higher, for example, in an optical disk with a diameter of 12 cm, there are known a 640-Mbyte compact disk (or CD), a 4.7 to 9.4-Gbyte DVD, and a 25 to 50-Gbyte Blu-ray disk.

In an optical disk apparatus, a laser beam which is emitted from an optical pick-up irradiates a disk record surface. Then, the reflected light is detected so that information can be read. Besides, in an optical disk apparatus, the state of a record film of the disk record surface is changed so that data can be recorded. At this time, if the laser beam is inclined with respect to the disk record surface, a coma aberration is produced. This hinders the regeneration and recording of a signal.

Thus, the inclination (hereinafter, referred to as the tilt) of the optical pick-up with respect to the disk record surface needs to be corrected. Taking this into account, there are proposed various tilt correction mechanisms.

For example, an optical pick-up is provided with a tilt sensor which detects the tilt of a disk. In such a mechanism, the optical pick-up is inclined or an objective lens is slanted, so that the tilt which is detected by this tilt sensor can be corrected.

On the other hand, Japanese Patent Laid-Open No. 8-167272 specification discloses a method of holding a disk in which the tilt of a disk itself is corrected. According to this configuration, a damper which holds a disk on a turntable is made as large as the disk. This helps correct the warp of the disk.

FIG. 10 shows a conventional disk-holding method in a general optical disk apparatus. FIG. 11 shows the disk-holding method in an optical disk apparatus which is described in Japanese Patent Laid-Open No. 8-167272 specification mentioned above.

As shown in FIG. 10, in the general optical disk apparatus, an optical disk 101 is placed on a turntable 102 and is clamped from above with a damper 103. Thereby, it is held on the turntable 102. The disk 101 is sandwiched between the damper 103 and the turntable 102, almost in the same position in the radius direction. Over substantially the same width, it is held by both of them. In this type of optical disk apparatus, the optical disk 101 which extends to the outside from the turntable 102 in the radius directions is deformed so as to hang down by its own weight. Therefore, the angle at which an objective lens inclines is adjusted on the side of an optical pick-up (not shown), or another such measure is taken. This prevents the optical characteristics from deteriorating.

On the other hand, in the disk apparatus which is described in Japanese Patent Laid-Open No. 8-167272 specification shown in FIG. 11, a clamper 104 which leads the disk 101 along the turntable 102 is designed to be large enough to reach nearly the entire surface of the disk 101. This damper 104 presses the optical disk 101 from above. Thereby, it functions as a stabilizer which reduces the warp of the disk 101.

However, in the conventional method of tilting the objective lens according to the detection of the tilt sensor, an additional drive mechanism has to be provided so that the tilt sensor or the optical pick-up can be inclined. This makes the configuration complicated and also makes it difficult to cut down the costs. In addition, electric power is additionally needed for adjusting the angle of the objective lens, thus increasing the power consumption. Besides, the more largely the angle is adjusted, the larger space is required. Thereby, making the whole unit smaller becomes difficult.

On the other hand, according to the configuration of the prior art which is described in Japanese Patent Laid-Open No. 8-167272 specification, the stabilizer 104 which is used as the clamper 104 is large, thus making it hard to make the unit smaller. Besides, the disk 101 is united and rotated with the stabilizer 104, and thus, the total mass becomes greater. This requires a high-torque motor, thereby raising the costs.

Furthermore, the disk 101 is supported on the turntable 102. In the disk 101, the weight of the disk 101 itself produces a downward moment on the outside from the turntable 102. This is one of the factors in a disk tilt. Even if the clamper 104 is provided, such a disk tilt cannot be removed.

Moreover, in an optical disk apparatus, an area in which a disk is held or a clamp area is defined, for example, at a diameter of 22 mm to 32 mm (or a radius of 11 mm to 16 mm) in the case of a CD or a DVD. However, in a practical optical disk apparatus, an objective lens of an optical pick-up certainly has access to the innermost area of a disk in the radius direction. Hence, a turntable of a disk motor is frequently designed to reach not over the whole clamp area, but only to its inside in the radius direction. Thereby, an objective-lens drive portion of the optical pick-up can move inward further. In contrast, in a disk-tilt measurement apparatus which examines the tilt of a disk, the disk is held in a standardized clamp area. This presents another disadvantage in that the value of a disk tilt which is measured in the disk-tilt measurement apparatus may be different from that of a disk tilt which is produced in the optical disk apparatus.

### BRIEF SUMMARY OF THE INVENTION

In view of the aforementioned disadvantages, it is an object of the present invention to provide a disk drive unit which is capable of restraining a disk from being tilted by the weight of the disk itself, using a simple configuration.

In order to resolve the disadvantages, a disk drive unit which drives a disk according to the present invention, comprising: a disk mounting portion which comes into contact with the disk and rotates together with the disk; and a pressure portion which presses the surface of the disk on the opposite side to the disk mounting portion and rotates together with the disk, wherein the positional relation between the pressure portion and the disk mounting portion is set so that a moment is generated in a direction where a moment generated by the weight of the disk itself is negated.

According to this configuration, the pressure portion and the disk mounting portion generate a moment in a direction where a moment generated by the weight of the disk itself is negated. Therefore, a disk tilt can be reduced.

Furthermore, a disk drive unit which drives a disk according to the present invention, may also comprise: a disk mounting portion which comes into contact with the lower surface of the disk and rotates together with the disk; and a pressure portion which is provided above the disk mounting portion, presses the upper surface of the disk and rotates together with the disk, wherein the pressure portion is located on the inside from the disk mounting portion in the radius direction.

According to this configuration, the pressure portion can restrain a disk from being tilted.

Moreover, a disk drive unit which drives a disk according to the present invention, may also comprise: a disk mounting portion which comes into contact with the upper surface of the disk and rotates together with the disk; and a pressure portion which is provided below the disk mounting portion, presses the lower surface of the disk and rotates together with the disk, wherein the disk mounting portion is located on the inside from the pressure portion in the radius direction.

According to this configuration, the disk mounting portion can restrain a disk from being tilted.

In addition, the above described disk drive unit may also be configured so that: the disk has a central hole; a contact portion is provided which comes into contact with the peripheral part of the central hole of the disk and rotates together with the disk; and the contact portion comes into contact with the disk, from the same side as the disk mounting portion with respect to the disk.

According to this configuration, even if a moment by the weight of a disk itself and a moment by the force applied from the contact portion are in the same direction, these moments can be reduced by the pressure portion and the disk mounting portion. This helps restrain the disk from being tilted.

In this case, it is preferable that: the contact portion has a tapered surface which can come into contact with the peripheral part of the central hole of the disk and is concentric with the rotational axis of the disk; and the tapered surface come into contact with the peripheral part of the central hole of the disk, so that the centering of the disk is executed.

Furthermore, the pressure portion may also be shaped like a plurality of protrusions which are each disposed at an interval in the circumferential direction. In this case, preferably, the pressure portion should be shaped so as to make point contact within the section in the radius direction.

Moreover, the present invention may also be an information recording and regeneration apparatus which includes the disk drive unit and an optical head, and records and regenerates information by allowing the disk drive unit to drive a disk and allowing the optical head to irradiate the disk.

As described above, the disk drive unit according to the present invention is capable of restraining a disk from being tilted by the weight of the disk itself, using a simple configuration.

These and other objects, features and advantages of the present invention will become more apparent upon reading of the following detailed description along with the accompanied drawings.

### BRIEF DESCRIPTION OF THE DRAWINGS

FIG. 1 is a perspective view of the main part of an optical disk apparatus with a disk drive unit according to a first embodiment of the present invention.

FIG. 2 is a sectional view of the disk drive unit.

FIG. 3A is a sectional view of the disk drive unit according to the first embodiment, showing a moment which works on a disk that is held on the disk drive unit. FIG. 3B is a sectional view of a conventional disk drive unit, showing a moment which works on a disk that is held on the disk drive unit. FIG. 3C is a sectional view of a disk-tilt measurement apparatus, showing a moment which works on a disk that is held on the disk-tilt measurement apparatus.

FIG. 4 is a graphical representation, showing a characteristic correlation between a clamp force and a disk tilt.

FIG. 5 is a graphical representation, showing a characteristic correlation between a moment ratio and a disk tilt.

FIG. 6 is a perspective view of a pressure member.

FIG. 7 is an enlarged sectional view of the pressure member and its vicinity.

FIG. 8 is a sectional view of a disk drive unit according to a second embodiment of the present invention.

FIG. 9 is a schematic block diagram, showing an information recording and regeneration apparatus according to a third embodiment of the present invention.

FIG. 10 is a schematic sectional view of a conventional disk drive unit.

FIG. 11 is a schematic sectional view of a disk drive unit which is described in Japanese Patent Laid-Open No. 8-167272 specification.

### DETAILED DESCRIPTION OF THE INVENTION

Hereinafter, a disk drive unit according to each embodiment of the present invention will be described in detail with reference to the accompanied drawings.

(First Embodiment)

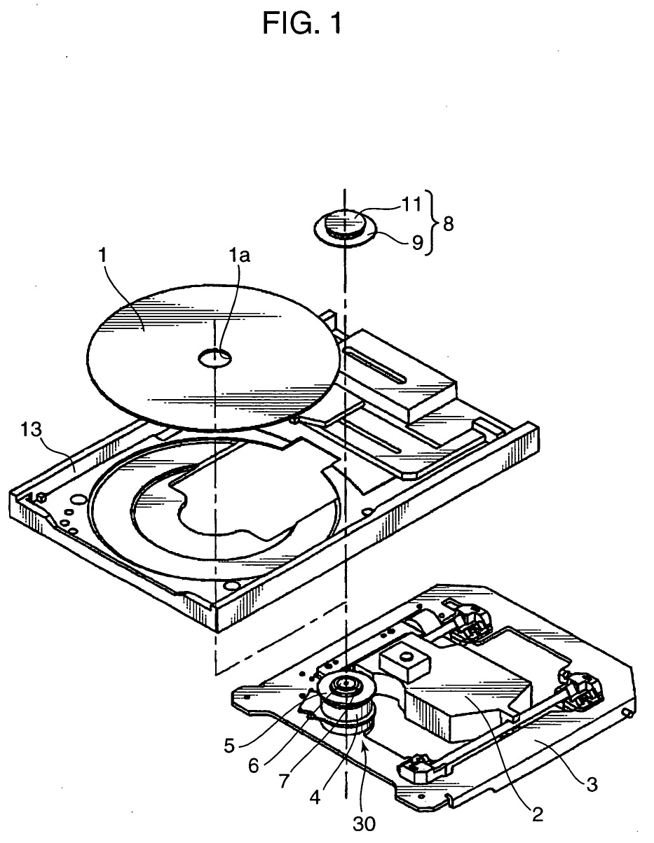

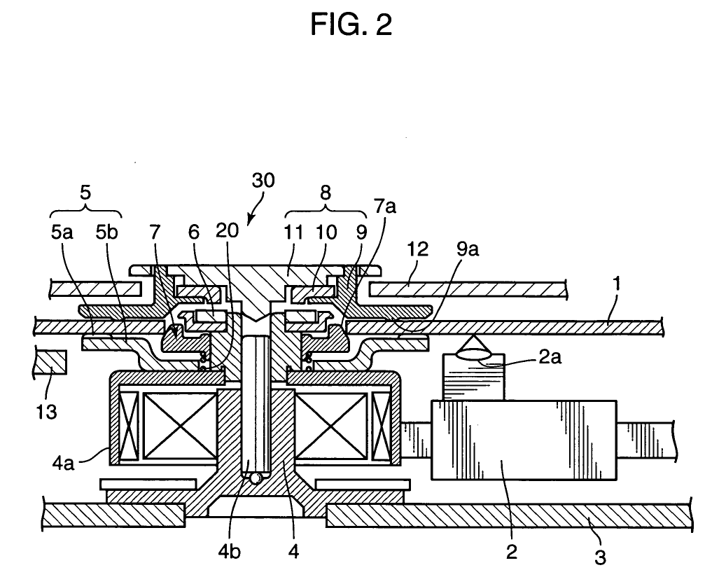

FIG. 1 and FIG. 2 show a disk drive unit 30 according to an embodiment of the present invention. FIG. 1 is a perspective exploded view of the main part of an optical disk apparatus which includes the disk drive unit 30. FIG. 2 is a sectional view of the disk drive unit 30, showing a state in which a disk 1 is held on a turntable 5.

The disk 1 is a circular plate which has a central hole 1a. It is provided with an information recording portion for recording information, or an information recording portion in which information is recorded. An optical head 2 reads information which is recorded in the information recording portion of the disk 1, or records information in the disk 1. The optical head 2 is held on a chassis 3 so that it can move in the radius directions along the information recording surface of the disk 1. On the chassis 3, a disk motor 4 is fixed for rotating the disk 1.

The disk motor 4 is united with: the turntable 5 which rotates together with a rotor 4a of the disk motor 4; a magnet 6 which is disposed above the turntable 5; an aligning ring 7 which is disposed at the center of the turntable 5; and a central shaft 4b.

The aligning ring 7 is used to set the center of the disk 1 to the rotational center of the disk motor 4. In other words, the aligning ring 7 has the function of centering the disk 1.

The turntable 5 is placed under the disk 1. The turntable 5 includes a table body portion 5b which is fixed on the rotor 4a of the disk motor 4, and a disk mounting portion 5a which is provided in the peripheral part of this table body portion 5b. The disk mounting portion 5a protrudes upward from the table body portion 5b. The upper-end surface of the disk mounting portion 5a is in contact with the lower surface of the disk 1. In other words, the disk 1 is pressed through its lower surface by the disk mounting portion 5a. The disk mounting portion 5a is made out of a material which has a great frictional coefficient, such as resin and rubber. This prevents the disk 1 from slipping while being rotated by a motor.

The aligning ring 7 has a radially end part with a tapered surface 7a whose diameter becomes smaller as it extends upward. This tapered surface 7a is concentric with the central shaft 4b of the disk motor 4. Besides, it is placed so as to come into contact with the central hole 1a of the disk 1. When the chassis 3 makes an upward motion to mount the disk 1 onto the turntable 5, the tapered surface 7a comes into contact with the peripheral part of the central hole 1a of the disk 1. Thereby, it guides the disk 1 to a position in which the center of the disk 1 meets with the rotational center of the disk motor 4. The aligning ring 7 is included in the concept of the contact portion according to the present invention. It is designed to come into contact with the radially inner end part (i.e., the peripheral part of the central hole 1a) of the lower surface of the disk 1.

The aligning ring 7 is supported by a coil spring 20 which is provided around the central shaft 4b of the disk motor 4, so that it can move in the directions of the rotational axis of the disk motor 4. The coil spring 20 presses the aligning ring 7 upward. In other words, via the aligning ring 7, the disk 1 is pressed upward at its interior-end part. Herein, this aligning ring 7's center-alignment mechanism allows of a sure centering of the disk 1, using relatively low-priced parts, such as stamped sheet-metal parts or molded resin parts.

A damper 8 is provided above the turntable 5. The clamper 8 includes a pressure member 9 which presses the disk 1, a magnetic member 10, and a holder 11 which holds the magnetic member 10 and the pressure member 9. The pressure member 9 and the holder 11 are held on an upper-cover member 12. Specifically, the upper-cover member 12 has a through hole, and the circumferential part of the through hole is sandwiched with a space between the pressure member 9 and the holder 11. Thereby, the pressure member 9 and the holder 11 are connected to the upper-cover member 12.

The magnetic member 10 is sandwiched and held between the pressure member 9 and the holder 11. The magnetic member 10 is placed above the magnet 6 which is disposed in the disk motor 4, so that it is attracted by this magnet 6. This magnetic attraction force causes the pressure member 9 to press the disk 1 downward. In this state, the disk 1 is kept between the pressure member 9 and the turntable 5. The pressure member 9 and the turntable 5 are designed to have substantially the same diameter.

In the lower surface of the pressure member 9, a pressure portion 9a is provided which protrudes downward. This pressure portion 9a is located in the middle of the pressure member 9 in the radius direction. The pressure portion 9a is in contact, at its lower-end part, with the disk 1. In other words, the disk 1 is pressed downward by the pressure portion 9a, at its upper surface on the inside from the disk mounting portion 5a in the radius direction.

Next, an operation will be described in which the disk 1 is mounted on the turntable 5 and is held by the damper 8.

The disk 1 is placed on a tray 13 and is carried into the disk apparatus by a disk loading mechanism (not shown). Thereafter, the chassis 3 moves up from a position in which it retreats downward and stays to avoid interference with the tray 13. This upward movement is made, using an up-and-down motion mechanism (not shown), such as an up-and-down motion motor and a cam. At this time, the disk motor 4 which is fixed on the chassis 3 also moves up. Thus, the above described aligning ring 7 comes into contact with the peripheral part of the central hole 1a of the disk 1. Thereby, it leads the disk 1 to a position in which the center of the disk 1 meets with the rotational axis of the disk motor 4. Then, the disk 1 is raised from the tray 13.

Immediately before the chassis 3 finishes ascending, the disk 1 comes into contact with the damper 8 which is held to the upper-cover member 12. Then, the damper 8 is lifted to a position where it is out of contact with the upper-cover member 12. Simultaneously, the magnet 6 which is placed in the central part of the disk motor 4 comes close to the magnetic member 10 of the damper 8, so that magnetic attraction force is generated. This magnetic attraction force is designed to be far greater than the force applied by the coil spring 20 of the aligning ring 7. Therefore, the disk 1's centering is executed at the same time when the aligning ring 7 is pressed down. Sequentially, the disk 1 is pressed down so as to certainly come into contact with the turntable 5. Then, it is fixed with keeping in contact with the turntable 5.

The disk 1 is released by moving the chassis 3 downward. This allows the magnet 6 to retreat downward, and thereby, the magnetic attraction force generated by it and the damper 8 is removed. At this time, the disk 1 is placed on the tray 13. The damper 8 is held to the upper-cover member 12, so that it stays above on standby.

Herein, the disk 1 is pressed onto the turntable 5 and held by the force produced from this pressure. However, the present invention is not limited to this configuration. For example, an attraction force may also be generated by providing a magnetic member on the side of the disk motor 4 and providing a magnet on the side of the damper 8. Besides, it is not limited to a magnetic attraction force by a magnet and a magnetic member. A spring member may also be used to secure such a force.

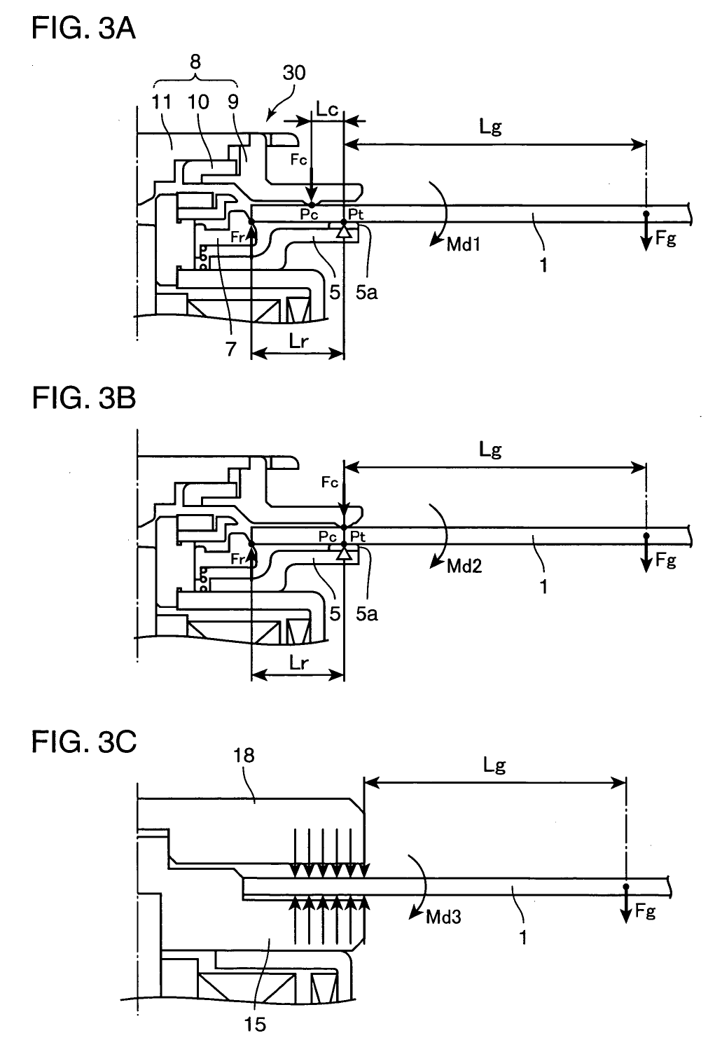

Next, a load and a moment which are borne on the disk 1 in a state where the disk 1 is held on the turntable 5 by the damper 8, are compared with those according to a conventional configuration, with reference to FIG. 3A to FIG. 3C. FIG. 3A to FIG. 3C are each a schematic sectional view, divided along the radius of the disk 1.

FIG. 3A is a sectional view of the disk drive unit 30 according to this embodiment in the radius direction. In this disk drive unit 30, the disk 1 is supported on the disk mounting portion 5a of the turntable 5. This support point on the disk mounting portion 5a is shown by Pt in the figure. On the disk 1, there are working: a support force at this support point Pt; as well as a pressure Fc (hereinafter, referred to as the clamp force) by the damper 8; a force Fr by the aligning ring 7; and a weight Fg of the disk 1 itself. Herein, to make the description simple, only parts which each have a unit width in the circumferential direction are taken into account. The weight Fg of the disk 1 itself is practically a distributed load, but it is assumed to work as a concentrated load on its center of gravity in the radius direction in the corresponding part. Herein, to make the description simple, all the loads shown in FIGS. 3A to 3C are each assumed to work on the corresponding part. Strictly speaking, the corresponding part is continuously distributed in the circumferential direction. Hence, it is different from a load or a moment which is generated in only one practical section.

In FIG. 3A, a moment is calculated around the support point Pt.

The weight of the disk 1 itself works as the concentrated load Fg in a position a distance Lg away on the outside from the support point Pt of the disk mounting portion 5a. Hence, a moment Mg by the weight of the disk 1 itself works in the positive direction (i.e., in the clockwise direction in FIG. 3A). Its value is expressed by the following formula.
Mg=Lg×Fg (1)

In other words, when the disk 1 is only placed on the turntable 5, the disk 1 tends to incline so as to hang down on the outside from the disk mounting portion 5a by its own weight.

On the other hand, the force Fr of the aligning ring 7 works in a position a distance Lr apart from the support point Pt. Hence, a moment Mr by the force Fr works in the positive direction. Its value is expressed by the following formula.
Mr=Lr×Fr (2)

In addition, the clamp force Fc works in a position a distance Lc away from the support point Pt. Hence, a moment Mc by the clamp force Fc works in the negative direction (i.e., in the counterclockwise direction in FIG. 3A). Its value is expressed by the following formula.
Mc=Lc×Fc (3)

Herein, as described earlier, in order to surely fix the disk 1 on the turntable 5, the clamp force Fc is set to be greater than the force Fr of the aligning ring 7.

As described so far, if the moment around the support point Pt is defined as Md1, the moment Md1 is expressed by the following formula.
Md1=Mg+Mr−Mc (4)

Hence, the moment Md1 works on the disk 1, as the residual component of Mg, Mr, Mc. This moment Md1 works on the disk 1 to rotate around the support point Pt, or works as energy which deforms the disk 1. In other words, the lower the moment Md1 becomes, the less effect it has on the disk 1's posture and deformation. This helps restrain the disk 1 from being tilted. In practice, the disk 1 is continuous in its circumferential direction, and thus, the moment Md1 is divided into components in the circumferential direction. Therefore, the disk 1 becomes stable when it keeps its balance after undergoing a certain rotation or deformation.

As described earlier, by the moment Mg and the moment Mr, the disk 1 bears a moment in the positive direction (i.e., in the right-handed direction) around the support point Pt. Specifically, it bears a moment which brings the periphery of the disk 1 downward. On the other hand, the moment Mc by the clamp force Fc works on the disk 1 in the direction where it negates this moment. In other words, a moment in a reverse direction to a moment which works on the disk 1 by the weight Fg of the disk 1 itself and the force Fr of the aligning ring 7 is actively added through the pressure portion 9a. This reduces the moment around the support point Pt which is given to the disk 1. Therefore, in the disk drive unit 30 according to this embodiment, the moment Md1 which is generated on the disk 1 becomes lower. This makes the disk 1's posture more stable.

Herein, the moment Mc depends upon how great the clamp force Fc is, and how far it is away from the support point Pt, or the distance Lc. Thus, the moment Mc can be arbitrarily obtained by adjusting Fc, Lc.

In addition, the support area in which the disk 1 is supported on the turntable 5 is located on the radially inner part of a clamp area which is defined on a CD or a DVD. The radius of this support area is, for example, about 12 to 14 mm.

Next, in a conventional disk drive unit shown in FIG. 3B, how to hold a disk will be described. In this disk drive unit, the position in which the clamp force Fc works is different from that of the disk drive unit 30 according to this embodiment shown in FIG. 3A. Specifically, the clamp force Fc's working point is located in almost the same radius position as the disk support point Pt of the turntable 5. Except for this, it is the same as that of FIG. 3A.

The moment Mc around the support point Pt by the clamp force Fc is approximately 0. Hence, a moment Md2 around the support point Pt which works on the disk 1 is expressed by the following formula.
Md2=Mg+Mr (5)

In other words, on the disk 1, the sum of the moment Mg by its own weight and the moment Mr by the aligning ring 7 is produced as a right-handed (i.e., positive-direction) moment. Specifically, in the conventional disk drive unit, different from the disk drive unit 30 according to this embodiment shown in FIG. 3A, the moment Mc which offsets Mg and Mr is not generated. Therefore, the disk 1 may incline in the direction where its periphery moves down. This tilt can make it difficult to record and regenerate a signal stably.

FIG. 3C is shown for reference. FIG. 3C is a radius-direction sectional view of a disk-tilt measurement apparatus which examines a tilt of the disk 1, showing how to hold the disk 1. The disk-tilt measurement apparatus is designed to clamp a clamp area which is used as the standards of the disk 1, by a predetermined clamp force. Thus, the disk-tilt measurement apparatus clamps the disk 1 over the entire clamp area of the disk 1. For example, in a CD or a DVD, an area whose radius is 11 mm to 16 mm is a clamp area. In the disk-tilt measurement apparatus, the disk mounting surface of a turntable 15 and the disk pressure surface of a clamper 18 are formed within the area whose radius is 11 mm to 16 mm.

Furthermore, in the disk-tilt measurement apparatus, there is no need to make the apparatus small. Thus, a magnet attraction force does not need generating in a small space, using a magnet or a magnetic member. As shown in FIG. 3C, the clamper 18 is made large, and a clamp force is obtained by its weight. As a result, in the disk-tilt measurement apparatus, the disk 1 is clamped by a clamp force which is several times as great as the clamp force of a disk drive unit.

Moreover, the disk-tilt measurement apparatus requires a high precision even if it is somewhat expensive, as well as a method of holding a disk in which a light load is applied on the disk. This is different from a disk drive unit which demands a cut in costs. For example, different from a disk drive unit, no aligning ring is used, and thus, the disk 1 is centered using a positioning pin. This positioning pin is cut with high precision. The positioning pin is inserted into the central hole 1a of the disk 1, so that the disk 1 can be positioned. Therefore, different from the disk drive unit 30, there is no need to press the periphery of the central hole 1a of the disk 1 by the tapered surface 7a. Hence, in the disk-tilt measurement apparatus, the force is not produced which pushes up the periphery of the central hole 1a of the disk 1.

In addition, in the disk-tilt measurement apparatus, as shown in FIG. 3C, the clamp force by the turntable 15 and the damper 18 can be approximated as a uniform load within the whole clamp area. Besides, it works from the opposite directions to each other and is balanced out. The disk 1 can be approximated as a fixed end in the clamp area. Thus, it can be thought that only the moment Mg by the weight Fg around the clamp area is generated on the disk 1. Hence, in the disk-tilt measurement apparatus, a moment Md3 around the fixed end which is produced on the disk 1 is expressed by the following formula.
Md3=Mg (6)

The disk 1 is with the fixed end within the clamp area. Thereby, even if the disk 1 is deformed by the moment Mg from its own weight, the interior end of the disk 1 can be prevented from being raised, thus restraining the disk 1 from being tilted. In other words, in the disk-tilt measurement apparatus, holding the disk 1 can cause little tilt. This is different from a conventional disk drive unit.

In contrast, the disk drive unit 30 according to this embodiment shown in FIG. 3A is configured so that the clamp force by the pressure member 9 can work between the support point Pt and the force point of the aligning ring 7. Thereby, the clamp force by the pressure member 9 is used to offset the moment by the weight of the disk 1 itself and the force of the aligning ring 7. This prevents the interior end of the disk 1 from being lifted, thus restraining the generation of any tilt. Consequently, without producing a great clamp force, the state in which the disk 1 is held in the disk-tilt measurement apparatus can nearly be realized.

Herein, the relation between the clamp force Fc and a disk tilt will be described.

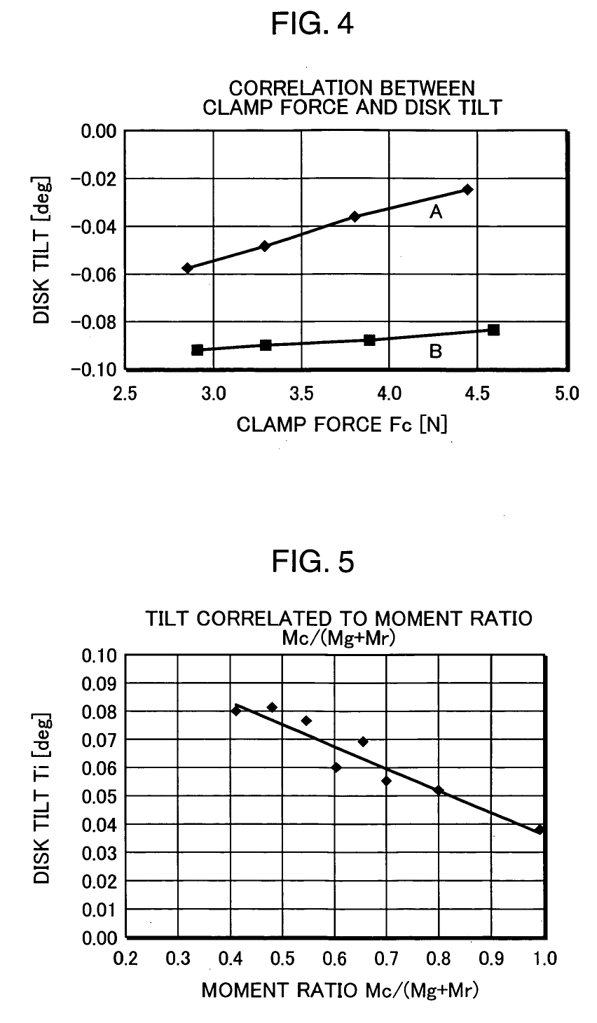

In the graph of FIG. 4, the clamp force Fc is taken as the horizontal axis, and the disk tilt is taken as the vertical axis. In FIG. 4, reference character A denotes a disk tilt which is obtained by the method of holding the disk 1 in the disk drive unit 30 according to this embodiment. In contrast, reference character B designates a disk tilt which is obtained by the method of holding the disk 1 in a conventional general disk drive unit. Herein, with respect to this disk tilt, the direction in which the periphery of the disk 1 is lifted up is set as the plus (or a sign of +).

As seen from the figure, in both cases, if the clamp force Fc becomes larger, the disk tilt shifts to the plus-direction. In other words, the larger the clamp force Fc becomes, the less the disk tilt in which the peripheral part of the disk 1 moves down becomes. However, in the conventional holding method shown by B, the disk support point and the working point of the clamp force are located in almost the same radius position. Therefore, even if the clamp force becomes larger, the disk tilt hardly changes. For example, even though the clamp force becomes larger, the disk tilt is only reduced to about −0.08 degrees from approximately −0.10 degrees. In contrast, according to this embodiment shown by A, the disk tilt can be lowered from some −0.06 degrees to around −0.02 degrees. In addition to this, as the clamp force increases, the disk tilt can be reduced more than the conventional one (B). Therefore, in the disk drive unit 30 according to this embodiment, if the clamp force is adjusted, the disk tilt can be more easily adjusted.

FIG. 5 shows the correlation between a moment ratio and a disk tilt. In this graph of FIG. 5, a moment ratio Mc/(Mg+Mr) is taken as the horizontal axis, and the disk tilt which is obtained by the holding method according to this embodiment is taken as the vertical axis. Herein, in this figure, the moment ratio Mc/(Mg+Mr) is the ratio of the absolute value of each moment, and the disk tilt is the absolute value of a tilt.

As can be seen from the figure, the higher the ratio Mc/(Mg+Mr) of a left-handed moment to a right-handed moment becomes, the less the disk tilt becomes. If the tolerance of the disk tilt is 0.06 degrees, the moment ratio should be set at 0.7 or higher. Or, if the tolerance of the disk tilt is 0.05 degrees, the moment ratio should be set at 0.8 or higher. Further, if the tolerance of the disk tilt is 0.04 degrees, the moment ratio should be set at 0.95 or higher. In short, if the moment Mc by the clamp force Fc is properly set, that helps restrain a disk tilt which is generated when a disk is held.

A total tilt is the tilt of the optical axis of the optical head 2 with respect to the record surface of the disk 1. This total tilt is produced by many factors, for example, an adjustment residual of the optical axis inside of the optical head 2 (i.e., the factor with respect to the optical system), an inclination of the guide shaft when the optical head 2 moves (i.e., the factor with respect to the drive system), a warp of the disk 1 itself, and the like. When an optical disk apparatus is designed, the tolerance value of the total tilt is separately determined for each of the optical system, the drive system and an optical disk itself. For example, the tolerance value for the drive system is set at 0.10 degrees to 0.20 degrees. Thus, it is desirable that the tolerance value for the disk be set much smaller than this. If the tolerance value for the disk tilt can be set, for example, at 0.04 degrees to 0.06 degrees, that is extremely advantageous.

As described so far, in the disk drive unit 30 according to this embodiment, the disk pressure position on the turntable 5 by the pressure portion 9a of the damper 8 is on the inside in the radius direction from the disk support position by the disk mounting portion 5a. Thereby, the moment generated by the weight of the disk 1 itself on the outside from the disk support position can offset the moment generated by the force of the aligning ring 7. Therefore, the disk tilt can be restrained using a simple configuration, thus making it possible to certainly record and regenerate a signal.

In addition, the disk tilt can be restrained, and thus, an objective lens 2a (see FIG. 2) can be adjusted at a narrower angle on the side of the optical head 2. Thereby, in the optical head 2, the electric-current value for holding the posture of the objective lens 2a can be lowered, thus reducing the power consumption. Besides, the angular range (or dynamic range) within which the objective lens 2a follows becomes narrower. This allows the objective lens 2a to move faster, thereby improving the optical characteristics. Further, the angle-adjustment width of the objective lens 2a becomes smaller. This is advantageous from the viewpoint of a space, which contributes to making such a disk apparatus thinner. In addition, the fact that the angle-adjustment width of the objective lens 2a can be made smaller, keeps a coma aberration from taking place in the objective lens 2a. This makes it possible to design the objective lens 2a more freely. Besides, even in a disk apparatus where no tilt correction is made on the side of the optical head 2, the precision which is required for each component part becomes lower. This contributes to a reduction in the costs.

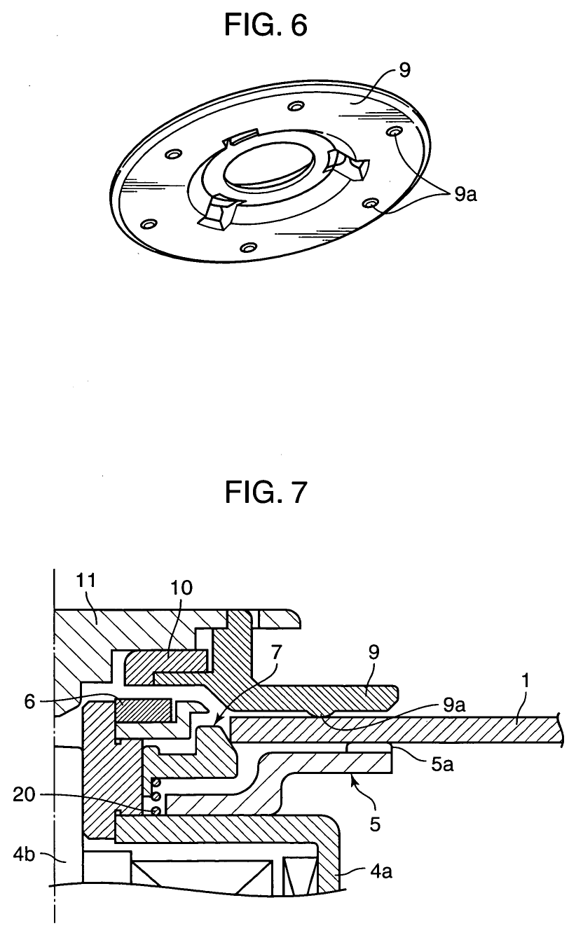

Herein, a specific configuration of the pressure portion 9a of the pressure member 9 will be described. As shown in FIG. 6, the pressure portion 9a may also be divided into a plurality which are each placed at an interval in the circumferential direction. FIG. 6 is a perspective view of the pressure member 9, seen from the disk direction (i.e., from below). In this embodiment, the pressure portion 9a is disposed at six places in the circumferential direction. Each pressure portion 9a is shaped like a protrusion. In this way, several pressure portions 9a which are small and jut out, are placed in the circumferential direction. Thereby, the flatness of the pressure surface which presses the disk 1 can be easily obtained. Besides, the points at which the disk 1 is pressed become certain, thus keeping the disk 1 in a more stable posture. Further, they are disposed at equal intervals in six places in the circumferential direction. Therefore, even if the surface of the disk 1 waves, that effect becomes less, thus keeping the disk 1 in a more stable posture. Conventionally, a disk mounting portion of a turntable is provided in a position opposite to a pressure portion of a pressure member. According to this configuration, the pressure area needs to be large enough to hold a disk stably. In contrast, in this embodiment, the pressure portion 9a of the pressure member 9 is provided between the disk mounting portion 5a of the turntable 5 and the contact portion of the aligning ring 7. Therefore, even if the pressure area of the pressure portion 9a is small, the disk 1 can be stably held. Herein, the pressure portion 9a is not limited to the configuration in which it is divided in the circumferential direction. For example, it may also be shaped like a ring which is continuous in the circumferential direction.

As shown in FIG. 7, the pressure portion 9a can be shaped so as to make point contact with the disk 1, within the section in the radius direction. For example, the pressure portion 9a may also have a triangular section, or an arc-shaped section, in the radius direction. These shapes make the point at which the disk 1 is pressed more certain. Thereby, the posture of the disk 1 becomes more stable.

Herein, in this embodiment, the interior-end part of the disk 1 is pressed by the aligning ring 7. However, the configuration is not limited to this. For example, the present invention can also be applied to a disk drive unit which is not provided with the aligning ring 7.

(Second Embodiment)

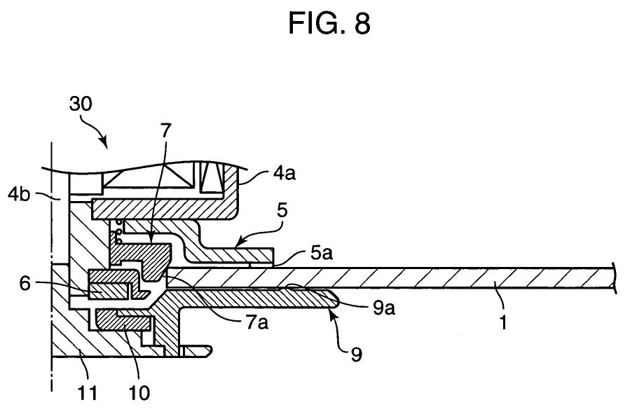

FIG. 8 partially shows the disk drive unit 30 according to a second embodiment of the present invention. As shown in this figure, according to the second embodiment, it has an upside-down structure, compared with the disk drive unit 30 according to the first embodiment.

Specifically, the turntable 5 is fixed to the lower-end part of the rotor 4a of the disk motor 4. The disk 1 is placed below the turntable 5.

The radially end part of the aligning ring 7 is turned upside down, compared with that according to the first embodiment. It has the tapered surface 7a whose diameter becomes smaller as it extends downward. Hence, the tapered surface 7a comes into contact with the upper end in the radially inner end part of the disk 1.

The pressure member 9 is placed below the turntable 5. The disk 1 is sandwiched between the pressure member 9 and the turntable 5.

The pressure member 9 has a larger external diameter than that of the turntable 5. The disk mounting portion 5a of the turntable 5 is located on the inside in the radius direction from the pressure portion 9a of the pressure member 9. As a result, the disk mounting portion 5a of the turntable 5 produces a moment on the disk 1 in the direction where a moment which is generated around the support point by the disk 1's own weight can be negated. The pressure portion 9a and the disk mounting portion 5a each have the same shape as those according to the first embodiment.

Even according to this second embodiment, a disk tilt can be reduced using a simple configuration, thus making it possible to certainly record and regenerate a signal.

Herein, the other configurations, operation and advantages are not described, but they are the same as those according to the first embodiment.

(Third Embodiment)

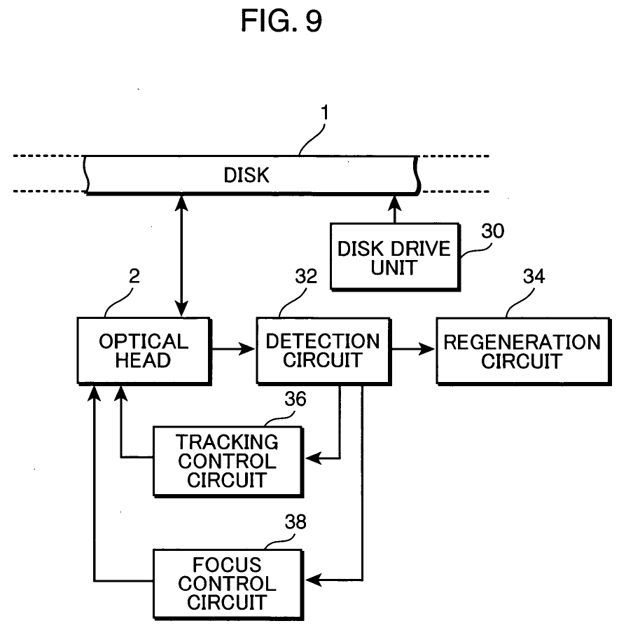

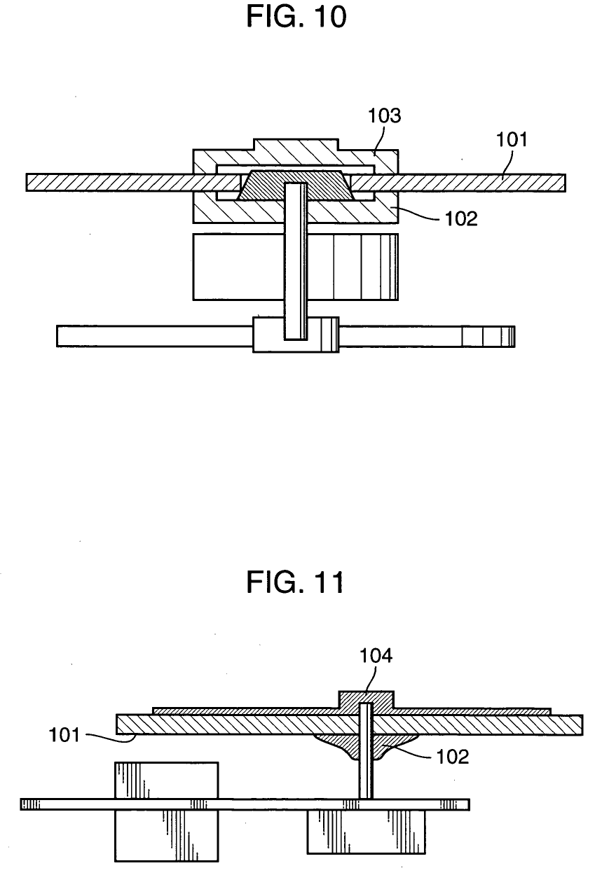

FIG. 9 shows an information recording and regeneration apparatus which regenerates information that is recorded in the disk 1 according to a third embodiment of the present invention. This information recording and regeneration apparatus includes as its main component elements: the optical head 2; the disk drive unit 30; a detection circuit 32; a regeneration circuit 34; a tracking control circuit 36; a focus control circuit 38; and the like. Herein, the information recording and regeneration apparatus may also be configured so as to record information in the disk 1 and regenerate information which is recorded in the disk 1.

The optical head 2 is provided, although they are not shown in the figure, with: a laser-beam source; a beam shaping device; a half mirror; an objective lens; an objective-lens actuator; and the like. The detection circuit 32 generates a regeneration signal, based on a reflected light which is emitted from the laser-beam source of the optical head 2 and is reflected by the disk 1. It also generates a tracking-error signal and a focus-error signal, based on branching light which branches from the emitted light. The regeneration circuit 34 regenerates information which is recorded in the disk 1, based on the regeneration signal. The tracking control circuit 36 controls the optical head 2 based on the tracking-error signal, so that a tracking error can be compensated. The focus control circuit 38 controls the optical head 2 based on the focus-error signal, so that a focus error can be compensated. The disk drive unit 30 is designed to have the configuration according to the first embodiment. Instead of this, it may also have the configuration according to the second embodiment.

Herein, the other configurations, operation and advantages are not described, but they are the same as those according to the first embodiment.

This application is based on Japanese patent application serial No. 2004-130957, filed in Japan Patent Office on Apr. 27, 2004, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

1. A disk drive unit which drives a disk, comprising:
a disk mounting portion which comes into contact with the disk and rotates together with the disk; and
a pressure portion which presses the surface of the disk on the opposite side to said disk mounting portion and rotates together with the disk,
wherein the positional relation between said pressure portion and said disk mounting portion is set so that a moment is generated in a direction where a moment generated by the weight of the disk itself is negated.

2. The disk drive unit according to claim 1, wherein:
the disk has a central hole;
a contact portion is provided which comes into contact with the peripheral part of the central hole of the disk and rotates together with the disk; and
said contact portion comes into contact with the disk, from the same side as said disk mounting portion with respect to the disk.

3. The disk drive unit according to claim 2, wherein:
said contact portion has a tapered surface which can come into contact with the peripheral part of the central hole of the disk and is concentric with the rotational axis of the disk; and
said tapered surface comes into contact with the peripheral part of the central hole of the disk, so that the centering of the disk is executed.

4. The disk drive unit according to claim 1, wherein said pressure portion is shaped like a plurality of protrusions which are each disposed at an interval in the circumferential direction.

5. The disk drive unit according to claim 4, wherein said pressure portion is shaped so as to make point contact within the section in the radius direction.

6. A disk drive unit which drives a disk, comprising:
a disk mounting portion which comes into contact with the lower surface of the disk and rotates together with the disk; and
a pressure portion which is provided above said disk mounting portion, presses the upper surface of the disk and rotates together with the disk,
wherein said pressure portion is located on the inside from said disk mounting portion in the radius direction.

7. The disk drive unit according to claim 6, wherein:
the disk has a central hole;
a contact portion is provided which comes into contact with the peripheral part of the central hole of the disk and rotates together with the disk; and
said contact portion comes into contact with the disk, from the same side as said disk mounting portion with respect to the disk.

8. The disk drive unit according to claim 7, wherein:
said contact portion has a tapered surface which can come into contact with the peripheral part of the central hole of the disk and is concentric with the rotational axis of the disk; and
said tapered surface comes into contact with the peripheral part of the central hole of the disk, so that the centering of the disk is executed.

9. The disk drive unit according to claim 6, wherein said pressure portion is shaped like a plurality of protrusions which are each disposed at an interval in the circumferential direction.

10. The disk drive unit according to claim 9, wherein said pressure portion is shaped so as to make point contact within the section in the radius direction.

11. A disk drive unit which drives a disk, comprising:
a disk mounting portion which comes into contact with the upper surface of the disk and rotates together with the disk; and
a pressure portion which is provided below the disk mounting portion, presses the lower surface of the disk and rotates together with the disk,
wherein said disk mounting portion is located on the inside from said pressure portion in the radius direction.

12. An information recording and regeneration apparatus, which includes a disk drive unit that drives a disk and an optical head, and regenerates information by allowing said disk drive unit to drive a disk and allowing said optical head to irradiate the disk, comprising:
a disk mounting portion which comes into contact with the disk and rotates together with the disk; and
a pressure portion which presses the surface of the disk on the opposite side to said disk mounting portion and rotates together with the disk,
wherein the positional relation between said pressure portion and said disk mounting portion is set so that a moment is generated in a direction where a moment generated by the weight of the disk itself is negated.

13. An information recording and regeneration apparatus, which includes a disk drive unit that drives a disk and an optical head, and regenerates information by allowing said disk drive unit to drive a disk and allowing said optical head to irradiate the disk, comprising:
a disk mounting portion which comes into contact with the lower surface of the disk and rotates together with the disk; and
a pressure portion which is provided above said disk mounting portion, presses the upper surface of the disk and rotates together with the disk,
wherein said pressure portion is located on the inside from said disk mounting portion in the radius direction.
